(19) United States
(12) Patent Application Publication
(10) Pub. No.: US 2005/0210117 A1
(43) Pub. Date: Sep. 22, 2005

(54) Remote controlled application program sharing framework and method for operating systems

(76) Inventors: Tung-Peng Wu, Taipei (TW); Chi-Min Liu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/055,068

(22) Filed: Feb. 11, 2005

(30) Foreign Application Priority Data
Feb. 12, 2004 (TW) 93103381

(51) Int. Cl. H04J 3/16

(52) U.S. Cl. 709/208

(57) ABSTRACT

A remote controlled application program sharing framework and method for operating systems, and it includes a remote transmitting unit for transmitting a data executing or a multimedia playing signal to a receiving unit, a decoding device decoding signals and transmitting a keyboard scan code, corresponding to the signal, to a second operating system, and then the second operating shares at least one data parameter and a multimedia playing system of a first operating system through an interface. Hence, the invention provides real time service and mobility, increases resource sharing, and avoids the re-installation of the application program.

### BACKGROUND OF THE INVENTION

1. Field of Invention

The invention relates to a remote controlled application program sharing framework and method for operation systems, in particular, the invention includes a remote transmitting unit for transmitting a data executing or a multimedia playing signal to a receiving unit, a decoding device decoding signals and transmitting a keyboard scan code, corresponding to the signal, to a second operating system, and then the second operating system shares at least one data parameter and a multimedia playing program in a first operating system through an interface.

2. Related Art

The computer is a product designed follows the formal logic, and it is interpretable for the instructions constituted of the formal language. Although the computer can't process the abstract knowledge directly, however, it can process the digital information expressed in the digital electrical medium.

The computer is designed for the purpose of facilitating people's work in the early periods, and the related applications are in the majority of the field. However, since the demands of courting the high speed and enjoying leisure time go higher from the improvement of information technology and computer, the integration of leisure time and the computer application follows. Hence, since one of the example of the integrated application is the multimedia service, the demand of computer operating system tending to integrate with it for reducing the wait time of system starting, saving resource, and adapting to the development of the mobility.

Linux and Windows are representative of the operating system. For Linux, open sources dispense with the cost and royalty on use of the operating system, however, the libraries, drivers of peripherals, user interfaces, and application programs are not exactly so compatible in the various chips and platform, and the strong and robust organization for technical supporting is insufficient so that the Linux developers and users expend on much groping time and costs of duplicated development. In contrast with Windows developed and supported by Microsoft, it is well supporting and collocation reliable, usable, compatible, efficient, easy to establish the enterprise websites and internet/intranet, speeding up operations of the development through the integrated application program server, and so on. However, the system resource consuming on the heavy loads influences the stability and the starting speed.

Household appliances become more and more necessary for domesticity nowadays. For example, viewer of the TV enjoying the entertainment by operating the remote controller without any limits, whereas the computer user must stay in front of the terminal for receiving the services provided by the computer.

### SUMMARY OF THE INVENTION

In view of the foregoing, the invention provides a remote controlled application program sharing framework and method for operating systems, herein it includes a remote transmitting unit for transmitting a remote signal to a receiving unit, a decoding device decoding the remote signal and transmitting a keyboard scan code, corresponding to the remote signal, to a second operating system, and then the second operating shares at least one data parameter and a multimedia playing program in a first operating system through an interface.

In addition, the invention provides the real time service and mobility without spatial limits, and it includes a remote transmitting unit for transmitting a data executing and a multimedia playing signal to a receiving unit, a decoding device for decoding the signals mentioned above, judging the keyboard scan code and transmitting to the second operating system.

Besides, the invention satisfies the user requirement for shortening the starting time for the second operating system, and it includes a remote transmitting unit for transmitting a data executing or a multimedia playing signal to a receiving unit, a decoding device decoding the signal and transmitting a keyboard scan code, corresponding to the signal, to a second operating system, and then the second operating shares at least one data parameter and a multimedia playing program in a first operating system through an interface.

Moreover, the present invention is storage-saving since the re-installing of the application program is avoided through sharing the multimedia playing program of the first operating system with the second operating system.

Furthermore, the present invention is power-saving since only the required resource of the multimedia playing program of the second operating system is started.

In view of the foregoing, the remote controlled application program sharing framework and method includes a first operating system for providing an executing environment, a second operating system installed in a second storage which has smaller size than the first storage, a remote transmitting unit for transmitting a data executing and a multimedia playing signal, a receiving unit for receiving the signals and then transmitting a keyboard scan code to the second operating system, the second operating receives the keyboard scan code and shares at least one data parameter and a multimedia playing program in a first operating system through an interface. Accordingly, the waiting time for starting the first operating system and the resource consuming will be reduced, and the portability, resource sharing, re-installation avoidance, and storage-saving can be achieved as well.

### BRIEF DESCRIPTION OF THE DRAWINGS

The invention will become more fully understood from the detailed description given herein below illustration only, and thus is not limitative of the present invention, and wherein:

FIG. 1 is a block diagram according to a preferred embodiment of a remote controlled application program sharing framework of the invention.

FIG. 2 is a block diagram according to a preferred embodiment of a remote controlled data parameter sharing framework of the invention.

FIG. 3 is a flow chart showing the steps according to a preferred embodiment of a remote controlled application program sharing method of the invention.

FIG. 4 is a flow chart showing the steps according to a preferred embodiment of a remote controlled data parameter sharing method of the invention.

### DETAILED DESCRIPTION OF THE INVENTION

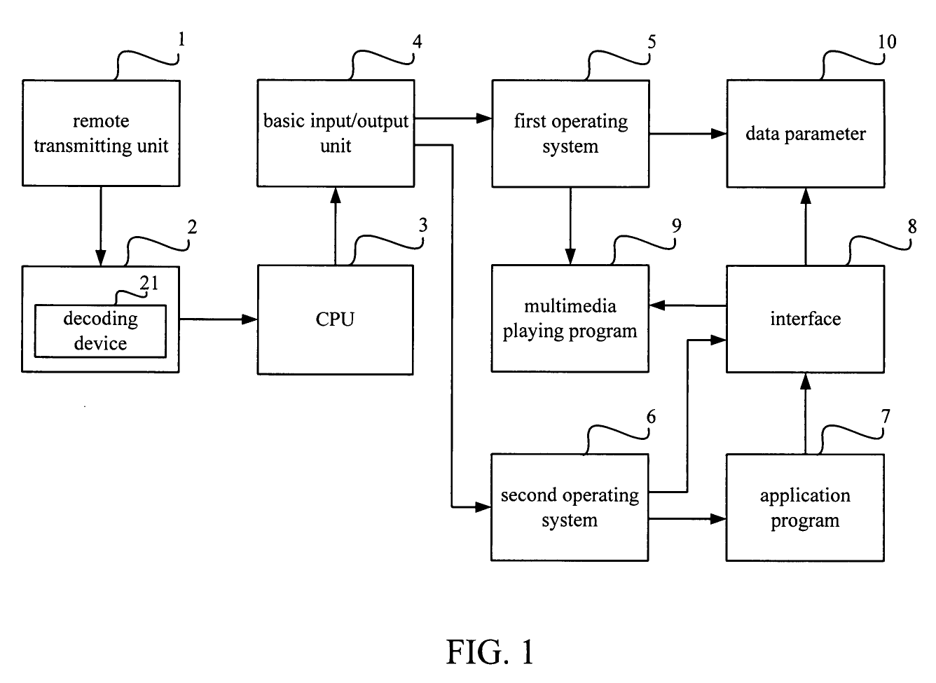

With reference to FIG. 1, the remote controlled application program sharing framework includes a remote transmitting unit 1 for transmitting a remote signal such as a data executing signal or a multimedia playing signal, a receiving unit 2 for receiving the data executing or the multimedia playing signal, and transmitting a keyboard scan code, a decoding device 21 in the receiving unit 2 for decoding the data executing and the multimedia playing signal, a CPU 3 for driving a basic input/output unit 4 which managing and controlling the boot setting procedure of a host, a first operating system 5 stored in a first storage for executing multiple programs concurrently, and a second operating system 6 stored in a first storage for executing at least one program. In other words, the embodiment includes a remote transmitting unit 1 for transmitting the data executing and the multimedia playing signal to the receiving unit 2, a decoding device 21 for decoding the data executing or the multimedia playing signal, and transmitting the keyboard scan code, corresponding to the signal, to the second operating system 6, and an interface 8 provided for an application program 7 to share the data parameter 10, and for the second operation system 6 to share the multimedia playing program 9 in the first operating system 5. Herein, the multimedia playing program 9 in the first operating system 5 plays the audio/video application program of the VCD and DVD, and the interface 8 receives the executing command of data parameter 10 issued by the application program 7 or the executing command of multimedia playing program 9 issued by the second operating system 6, and then transforms the data parameter 10 and the parameter of the multimedia playing program 9 into the executable format of the second operating system 6.

Moreover, the first operating system 5 consuming more system resources than the second operating system 6, the first operation system 5 can be the windows XP, Windows NT, Window 98, Windows 2000, Windows Me, and the second operating system 6 can be the Linux operating system.

Besides, the first storage storing the first operating system 5 and the multimedia playing program 9 can be a hard disk or a read-only memory, whereas the second storage storing the second operating system 6 can be a hard disk with/without the universal serial bus interface and a read-only memory. Hence, the hard disk with the universal serial bus interface that stores the second operating system 6 can be used in any host with slots, and the basic input/output unit 4 is customized and set to start the second operating system 6 for sharing the multimedia playing program 9 in the first operating system 5.

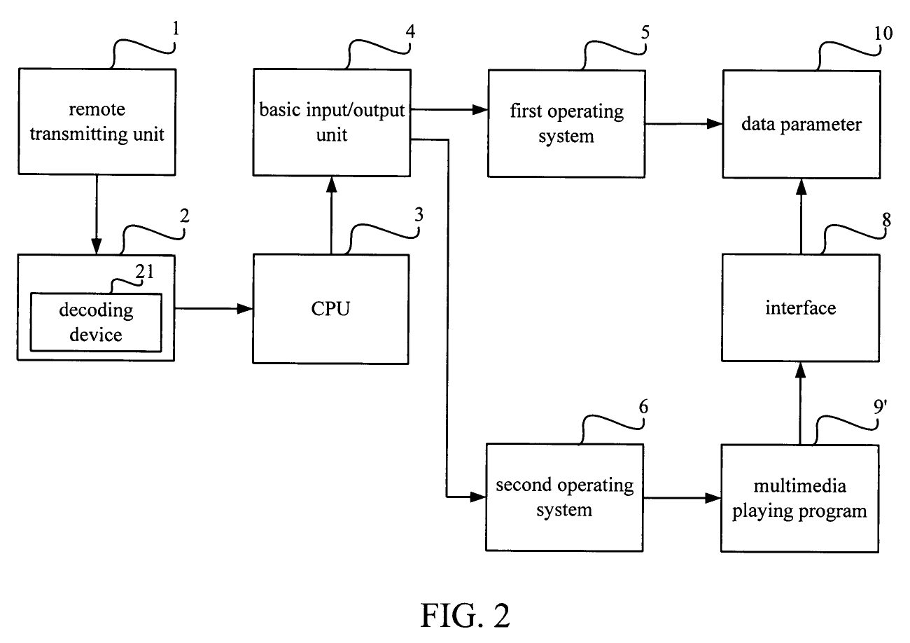

With reference to FIG. 2, the multimedia playing program 9′ installed in the second operating system 6, and the embodiment includes a remote transmitting unit 1 for transmitting the data executing and or multimedia playing signal to the receiving unit 2, a decoding device 21 for decoding the data executing and the multimedia playing signal, and transmitting the keyboard scan code to the second operating system 6, and the second operation system shares the data parameter 10 in the first operating system 5 through an interface 8. In addition, the interface 8 transforms the data parameter 10 into the executable format of the multimedia playing program 9′.

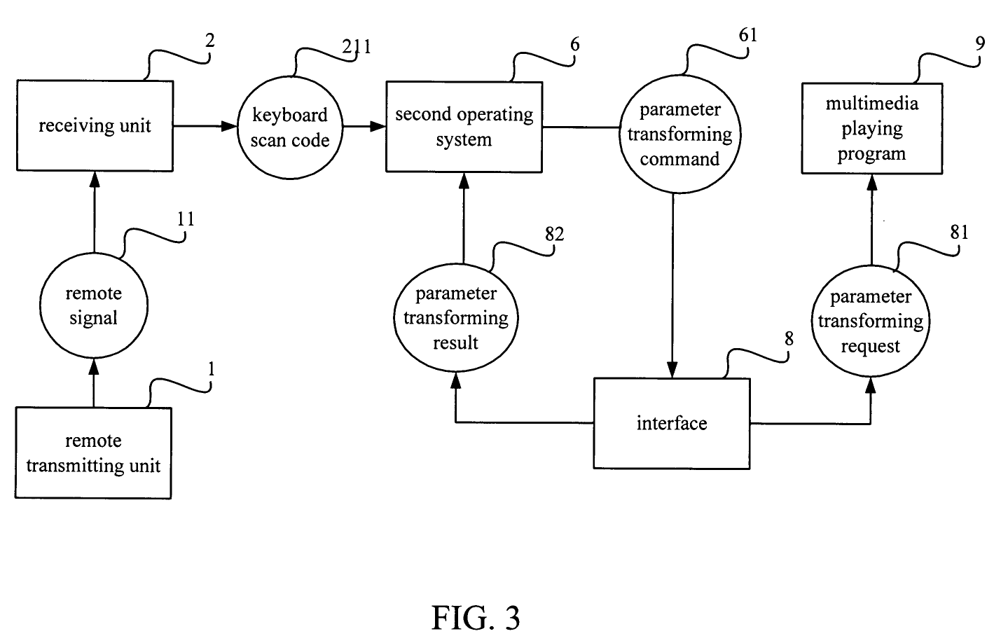

With reference to FIG. 3, In the embodiment, an end user transmits a remote signal 11 to the receiving unit 2, and the decoding device 21 in the receiving unit 2 decodes the remote signal 11 and transmitting the keyboard scan code, corresponding to the remote signal 11, to the second operating system 6 and a parameter transform request 61 to the interface 8. The interface 8 stores the executable format of of the multimedia playing program 9 in the first operating system 5 through a parameter transform request 81, transforms the parameter of multimedia playing program 9 into the executable format of the second operating system 6, transmits a parameter transform result 82 to the second operating system 6 to share the multimedia playing program 9, and transforms the parameter of multimedia playing program 9 to the executable format of the first operating system 5 after execution.

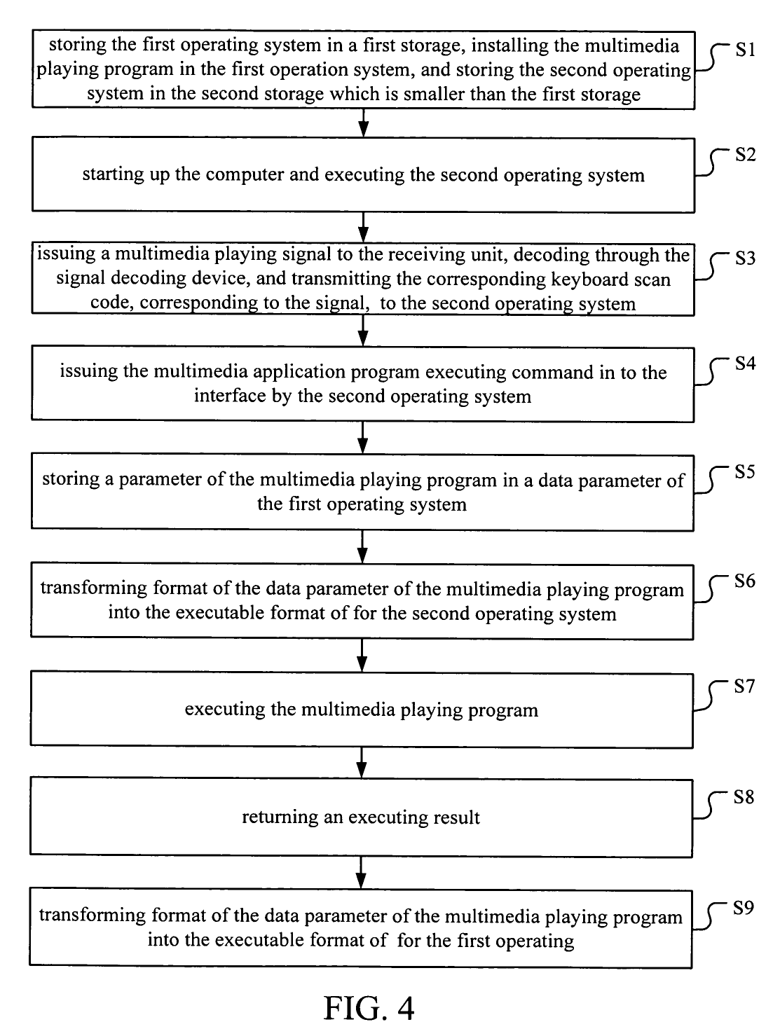

With reference to FIG. 4, the embodiment includes the steps of storing the first operating system in a first storage, installing the multimedia playing program in the first operation system, and storing the second operating system in the second storage which is smaller than the first storage in step S1; starting up the computer and executing the second operating system in the step S2; issuing a multimedia playing signal to the receiving unit, decoding through the decoding device, and transmitting the keyboard scan code, corresponding to the signal, to the second operating system in the step S3; issuing the multimedia application program executing command to the interface by the second operating system in the step S4; storing a parameter of the multimedia playing program in the first operating system in the step S5; transforming the parameter of the multimedia playing program into the executable format of the second operating system in the step S6; executing the multimedia playing program in the environment of the second operation system in the step S7; returning an executing result in the step S8; and transforming the parameter of the multimedia playing program into the executable format of the first operating in the step S9.

As mentioned above, the remote controlled application program sharing framework and method for operating systems of the invention includes a remote transmitting unit for transmitting a data executing and a multimedia playing signal, a receiving unit for receiving and transmitting a keyboard scan code to the second operating system and a decoding device for decoding, and the second operating system a shares at least one data parameter and the multimedia playing program of the first operating system through an interface. Accordingly, the waiting time for starting the first operating system and the resource consuming will be reduced, and the portability, resource sharing, re-installation avoidance, and storage-saving can be achieved as well.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1. A remote controlled application program sharing framework for operating systems, comprising:
a first operating system comprises at least one data parameter recorded in at least one a file system;
a remote transmitting unit for transmitting a remote signal;
a receiving unit for transmitting a keyboard scan code corresponding to the remote signal; and
a second operating for receiving the keyboard scan code and executing an application program;
wherein the application program executed in the second operating system accessing the data parameter of the file system of the first operating system through an interface.

2. The framework of claim 1, wherein the remote transmitting unit is selected from a personal digital assist (PDA), a cellular phone, and a remote controller.

3. The framework of claim 1, further comprising:
a basic input/output unit for management and controlling a host boot setting.

4. The framework of claim 1, wherein the interface transforming the data parameter to an executed format of the second operating system.

5. The framework of claim 1, further comprising:
a first storage for storing the first operating system.

6. The framework of claim 5, wherein the first storage is a hard disk.

7. The framework of claim 5, wherein the first storage is a related storage.

8. The framework of claim 7, wherein the related storage is a read-only memory.

9. The framework of claim 1, further comprising:
a second storage for storing the second operating system.

10. The framework of claim 9, wherein the second storage is a hard disk with a universal serial bus interface.

11. The framework of claim 9, wherein the second storage is a read-only memory.

12. The framework of claim 9, wherein the second storage is a related storage.

13. The framework of claim 12, wherein the related storage is a hard disk.

14. A remote controlled application program sharing method for operating systems, comprising:
providing a first operating system and a second operating system;
providing at least one data parameter in a file system of the first operating system;
transmitting a remote signal to a receiving unit;
transmitting a keyboard scan code, corresponding to the remote signal, to the second operating system;
executing an application program corresponding to the keyboard scan code in the second operating system; and
accessing the data parameter of the first operating system through an interface.

15. The method of claim 14, wherein the remote transmitting unit is selected from a personal digital assist (PDA), a cellular phone, and a remote controller.

16. The method of claim 14, further comprising:
a basic input/output unit for management and controlling a host boot setting.

17. The method of claim 14, wherein the interface transforming the data parameter to an executed format of the second operating system.

18. The method of claim 14, further comprising:
storing the first operating system in the first storage.

19. The method of claim 18, wherein the first storage is a hard disk.

20. The method of claim 18, wherein the first storage is a related storage.

21. The method of claim 20, wherein the related storage is a read-only memory.

22. The method of claim 14, further comprising:
storing the second operating system in the second storage.

23. The method of claim 22, wherein the second storage is a hard disk with a universal serial bus interface.

24. The method of claim 22, wherein the second storage is a read-only memory.

25. The method of claim 22, wherein the second storage is a related storage.

26. The method of claim 25, wherein the related storage is a hard disk.

27. A remote controlled application program sharing framework for operating systems, comprising:
a first operating system;
a second operating system;
a multimedia playing program installed in the first operating system for playing at least one audio/video application program;
a remote transmitting unit for transmitting a remote signal; and
a receive unit for transmitting a keyboard scan code corresponding to the remote signal, to the second operation system;
wherein the second operating system sharing the multimedia playing program of the first operating system through an interface.

28. The framework of claim 27, wherein the remote transmitting unit is selected from a personal digital assist (PDA), a cellular phone, and a remote controller.

29. The framework of claim 27, further comprising:
an basic input/output unit for management and controlling a host boot setting.

30. The framework of claim 27, wherein the interface transforming the data parameter to an executed format of the second operating system.

31. The framework of claim 27, further comprising:
a first storage for storing the first operating system.

32. The framework of claim 31, wherein the first storage is a hard disk.

33. The framework of claim 31, wherein the first storage is a related storage.

34. The framework of claim 33, wherein the related storage is a read-only memory.

35. The framework of claim 27, further comprising:
a second storage for storing the second operating system.

36. The framework of claim 35, wherein the second storage is a hard disk with a universal serial bus interface.

37. The framework of claim 35, wherein the second storage is a read-only memory.

38. The framework of claim 35, wherein the second storage is a related storage.

39. The framework of claim 38, wherein the related storage is a hard disk.

40. A remote controlled application program sharing method for operating systems, comprising:
providing a first operating system and a second operating system;
providing a multimedia playing program in the first operating system;
transmitting a remote signal to a receiving unit; and
transmitting a keyboard scan code, corresponding to the remote signal, to the second operating system;
wherein the second operating system sharing the multimedia playing program of the first operating system through an interface.

41. The method of claim 40, wherein the remote transmitting unit is selected from a personal digital assist (PDA), a cellular phone, and a remote controller.

42. The method of claim 40, further comprising:
a basic input/output unit for management and controlling a host boot setting.

43. The method of claim 40, wherein the interface transforming the data parameter to an executed format of the second operating system.

44. The method of claim 40, further comprising:
storing the first operating system in the first storage.

45. The method of claim 44, wherein the first storage is a hard disk.

46. The method of claim 44, wherein the first storage is a related storage.

47. The method of claim 46, wherein the related storage is a read-only memory.

48. The method of claim 40, further comprising:
storing the second operating system in the second storage.

49. The method of claim 48, wherein the second storage is a hard disk with a universal serial bus interface.

50. The method of claim 48, wherein the second storage is a read-only memory.

51. The method of claim 48, wherein the second storage is a related storage.

52. The method of claim 51, wherein the related storage is a hard disk.

53. A remote controlled application program sharing framework for operating systems, comprising:
a first operating system;
at least one data parameter stored in a file system of the first operating system;
a multimedia playing program executed in the second operating system for playing at least one audio/video application program;
a remote transmitting unit for transmitting a remote signal; and
a receiving unit for transmitting a keyboard scan code, corresponding to the remote signal, to the second operating system, wherein the multimedia application program executed in the second operating system accessing the data parameter of the first operating system through an interface.

54. The framework of claim 53, wherein the remote transmitting unit is selected from a personal digital assist (PDA), a cellular phone, and a remote controller.

55. The framework of claim 53, further comprising:
a basic input/output unit for management and controlling a host boot setting.

56. The framework of claim 53, wherein the interface transforming the data parameter to an executed format of the second operating system.

57. The framework of claim 53, further comprising:
a first storage for storing the first operating system.

58. The framework of claim 57, wherein the first storage is a hard disk.

59. The framework of claim 57, wherein the first storage is a related storage.

60. The framework of claim 59, wherein the related storage is a read-only memory.

61. The framework of claim 53, further comprising:
a second storage for storing the second operating system.

62. The framework of claim 61, wherein the second storage is a hard disk with a universal serial bus interface.

63. The framework of claim 61, wherein the second storage is a read-only memory.

64. The framework of claim 61, wherein the second storage is a related storage.

65. The framework of claim 64, wherein the related storage is a hard disk.

66. A remote controlled application program sharing method for operating systems, comprising:
providing a first operating system and a second operating system;
providing at least one data parameter in a file system of the first operating system;
transmitting a remote signal to a receiving unit;
transmitting a keyboard scan code corresponding to the remote signal, to the second operating system;
executing an application program, corresponding to the keyboard scan code in the second operating system; and
accessing the data parameter of the first operating system through an interface.

67. The method of claim 66, wherein the remote transmitting unit is selected from a personal digital assist (PDA), a cellular phone, and a remote controller.

68. The method of claim 66, further comprising:
a basic input/output unit for management and controlling a host boot setting.

69. The method of claim 66, wherein the interface transforming the data parameter to an executed format of the second operating system.

70. The method of claim 66, further comprising:
storing the first operating system in the first storage.

71. The method of claim 70, wherein the first storage is a hard disk.

72. The method of claim 70, wherein the first storage is a related storage.

73. The method of claim 72, wherein the related storage is a read-only memory.

74. The method of claim 66, further comprising:
storing the second operating system in the second storage.

75. The method of claim 74, wherein the second storage is a hard disk with a universal serial bus interface.

76. The method of claim 74, wherein the second storage is a read-only memory.

77. The method of claim 74, wherein the second storage is a related storage.

78. The framework of claim 77, wherein the related storage is a hard disk.
